(19) United States
(12) Patent Application Publication
(10) Pub. No.: US 2004/0157653 A1
(43) Pub. Date: Aug. 12, 2004

(54) Slide mechanism and portable phonse using the same

(76) Inventor: Hideo Kato, Kanagawa (JP)

Correspondence Address: NOTARO AND MICHALOS, 100 DUTCH HILL ROAD, SUITE 110, ORANGEBURG, NY, 10962-2100, US

(21) Appl. No.: 10/764,952

(22) Filed: Jan. 26, 2004

(30) Foreign Application Priority Data
Jan. 29, 2003 (JP) JP2003-021105

(51) Int. Cl. H04M 1/00

(52) U.S. Cl. 455/575.4

(57) ABSTRACT

A slide mechanism to connect a first member and a second member formed separately from each other to be slidable in one direction to form a closed state in which the first member and the second member overlap one another and to form an opened state in which the top face of either member is exposed, is composed of a hinge device provided with a guide member attached on the front end of a hinge case installed on both sides of either one of the first member or the second member facing toward both sides of the other member, allowing the guide member to expose to be movable forward and backward by being biased slidably in one direction; a guide groove provided on the other member out of the above-described first and second members to guide the guide member of the hinge device in an engaged state; and an recessed portion to receive and lock the guide groove at an appropriate position of the guide groove. Further a box of transmitter composing a first member of a portable phone and a box of receiver composing a second member of the portable phone are provided separately, and the portable phone forms a closed state covering the top face of the transmitter with the receiver, and an opened state of sliding the receiver in one direction from the transmitter to expose the top face thereof by connecting the respective boxes of the transmitter and the receiver slidably to each other via the slide mechanism, and at the same time, the receiver forms an obtuse angle with the transmitter by lifting a sliding tip end of the receiver slightly during sliding of the receiver.

### BACKGROUND OF THE INVENTION

1. Field of the Invention

The present invention relates to a slide mechanism connecting a first member and a second member slidably to each other, and a portable phone using the slide mechanism.

2. Description of the Relevant Art

Generally, a portable phone is composed of a transmitter provided with a key board section and a microphone section, and a receiver provided with a display device and a speaker section. A portable phone having a transmitter and a receiver installed putting both side by side in a longitudinal direction in a box, and a portable phone as disclosed in Japanese Patent Laidopen No. 2002-300243 in which a transmitter and a receiver are put in separate boxes respectively, both connected in an openable and shuttable manner using a hinge, are well-known.

### SUMMARY OF THE INVENTION

Among the-above mentioned types of phones, the one which has a transmitter and a receiver in separate boxes, both being connected to each other in an openable and shuttable manner with a hinge brings advantages that since the total length of the phone becomes in half by folding the transmitter and receiver when not in use, it can be and handled conveniently, and that unconscious key inputs can be prevented when not in use, however it is sometimes troublesome because the transmitter and receiver have to be opened every time the display screen of the display device needs to be looked at.

An object of the present invention is to provide a slide mechanism widely applicable to small size electronic equipment such as a pocket computer to be described later when a transmitter provided with a key board section is assumed to be a first member, a receiver provided with a display device being a second member.

Another object of the present invention is to provide a portable phone which places a transmitter being the first member and a receiver being the second member one upon the other to set the portable phone compact with no bulkiness when not in use, can be easily stored and handled, and further make it possible to view a content displayed on a screen of the display device on the receiver in a compactly arranged state, and when in use, the transmitter and the receiver can make a bent form nearly in a shape of the letter V when seen from the side.

In order to achieve the above-described object, the present invention constructs a slide mechanism to connect a first member and a second member formed separately from each other to be slidable in one direction to form a closed state in which the first member and the second member overlap one another, and to form an opened state in which the top face of either member is exposed, including: a hinge device provided with a guide member on the tip attached to one side of either the first member or the second member, allowing the guide member to expose to be movable forward and backward by being biased slidably in one direction; a recessed portion provided on the other member out of the above-described first and second members to receive the guide member of the hinge device at a predetermined slide position; and an engagement means to engage to prevent the transmitter and the receiver from separating.

At this time, the present invention can construct the slide mechanism including: a hinge device provided with a guide member attached on the front end of a hinge case installed on both sides of either one of the first member or the second member facing toward both sides of the other member, allowing the guide member to expose to be movable forward and backward by being biased slidably in one direction; a guide groove provided on the other member out of the above-described first and second members to guide the guide member of the hinge device in an engaged state; and an recessed portion to receive and lock the guide groove at an appropriate position of the guide groove.

Further, the present invention can provide the guide groove in a bent shape so that the second member forms an obtuse angle with the first member, when the first member and the second member are in an opened state.

The present invention is structured to provide a box of a transmitter of a portable phone being a first member and a box of a receiver of the portable phone being a second member separately, and the portable phone forms a closed state covering the top face of the transmitter with the receiver, and an opened state of sliding the receiver in one direction from the transmitter to expose the top face thereof by connecting the transmitter and the receiver slidably to each other via the slide mechanism.

At that time, the present invention provides the guide groove in a bent shape so that the receiver forms an obtuse angle with the transmitter by lifting a sliding tip end of the receiver slightly during sliding of the receiver when the transmitter and the receiver are in an opened state.

### BRIEF DESCRIPTION OF THE DRAWINGS

FIG. 1 is a side elevational view in a closed state of a transmitter and a receiver composing a portable phone applying a slide mechanism relating the present invention;

FIG. 2 is a plane view of the portable phone applying the slide mechanism relating to the present invention;

FIG. 3 is a side elevational view in a closed state of the transmitter and the receiver composing the portable phone applying the slide mechanism relating to the present invention;

FIG. 4 is a plane view in an opened state of the portable phone applying the slide mechanism relating to the present invention;

FIG. 5 is an enlarged sectional view along the line A-A in FIG. 2;

FIG. 6 is an enlarged view of a portion pointed by an arrow line A in FIG. 5;

FIG. 7 is a vertical sectional view showing an internal mechanism of a hinge device of the slide mechanism relating to the present invention;

FIG. 8 is a sectional view along the line B-B in FIG. 7;

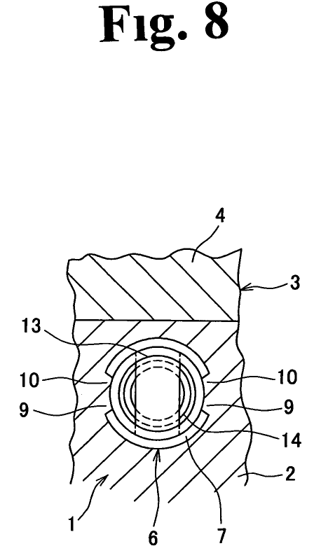

FIG. 9 is an explanatory view showing another embodiment of an engagement means of a slide mechanism relating to the present invention; and

FIG. 10 is an explanatory view showing still another embodiment of an engagement means of a slide mechanism relating to the present invention.

### DETAILED DESCRIPTION OF THE PREFERRED EMBODIMENT(S)

Hereinafter, an embodiment of the present invention applied to a portable phone will be explained. However, a slide mechanism relating to the present invention can be applied to a portable terminal, for instance, such as Zaurus (trade name), a desk-top calculator, a pocket computer, a portable game machine, an ashtray, a lid of a case, and so on.

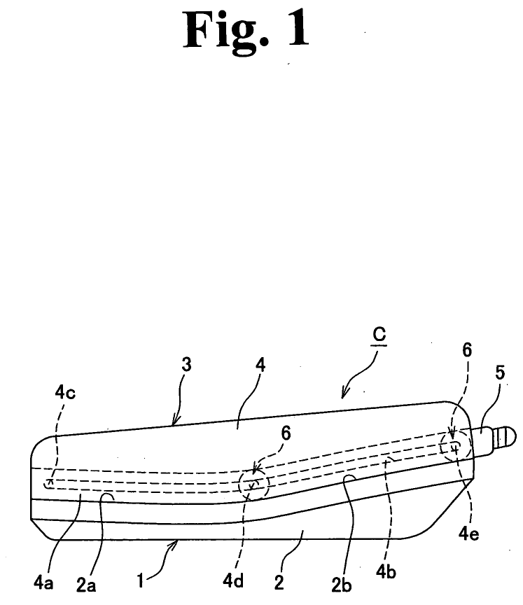

The drawings show an embodiment of the present invention, and in FIG. 1 to FIG. 4, reference symbol C shows a portable phone relating to the present invention, numeral 1 denotes a transmitter of a portable phone composing, for instance, a first member, and numeral 2 denotes a box for the transmitter. There provides a microphone section 1a and a keyboard section 1b on the face of the first member. The one overlaid on the top portion of the first member 1, attached slidably in a longitudinal direction is, for instance a receiver 3 of the portable phone composing a second member, and numeral 4 is a box thereof. On the face of the second member 3, a speaker section 3a and a display device 3b are provided. Note that numeral 5 denotes an antenna. The antenna 5 is attached on the second member 3 side, but it is sometimes attached on the first member 1 side as a matter of course.

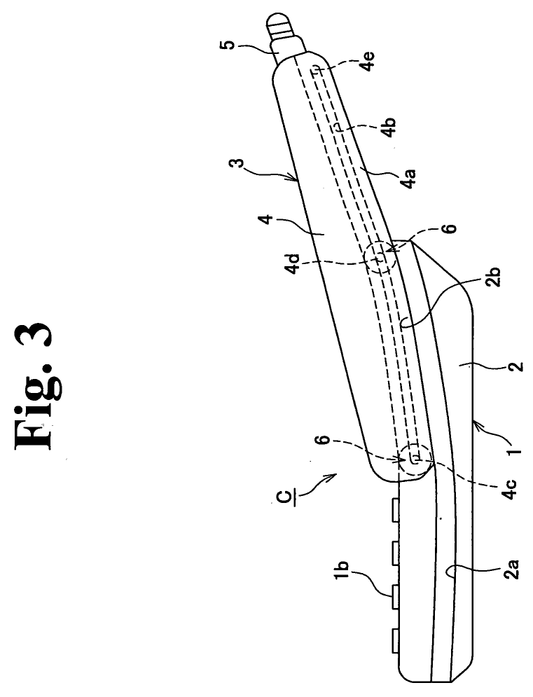

Especially, as shown in FIG. 1 to FIG. 3, shelf portions 2a and 2a which are bent upward are formed on a position a little lower than the top face portion on the top face side of the box 2 of the transmitter 1 composing the first member. The box 4 of the receiver 3 composing the second member is overlaid on the box 2. On both sides of the box 4, skirt portions 4a and 4a of which bottom end line is bent downward, matching to the shape of the shelf portions 2a and 2a bent upward are provided vertically. The skirt portions 4a and 4a are able to sandwich both sides of the top face portion of the box 2, and slide in the longitudinal direction along the shelf portions 2a and 2a. When sliding, the sliding tip end side of the skirt portions goes up from the horizontal state, guided by the curved face 2b and 2b of the shelf portions 2a and 2a, to form an obtuse angle between the transmitter 1, making nearly V shape when seen from the side, as shown especially in FIG. 3. In the inside of the skirt portions 4a and 4a, guide grooves 4b and 4b curved upward in parallel with the shelf portions 2a and 2a are provided, and at the same time, recessed portions 4c, 4d, 4e, 4c, 4d, and 4e having the widths a little wider than those of the guide grooves 4b and 4b are formed at both sides and the central portions of the guide grooves 4b and 4b. Note that the positions to form these recessed portions can be voluntarily determined.

A modified embodiment of arranging the shelf portions 2a and 2a on the box 4 sides of the second member 3, and the skirt portions 4a and 4a on the box 2 sides of the first member 1 is also conceivable.

Respective both sides of the central portions and the upper end portion side of the upward slanting portions 2b and 2b on the sides of the shelf portions 2a and 2a of the box 2 of the first member, respective hinge cases 7 of 4 pieces of hinge devices 6 are attached by setting inside the setting holes 8, while the tip ends are facing the skirt portions 4a and 4a sides.

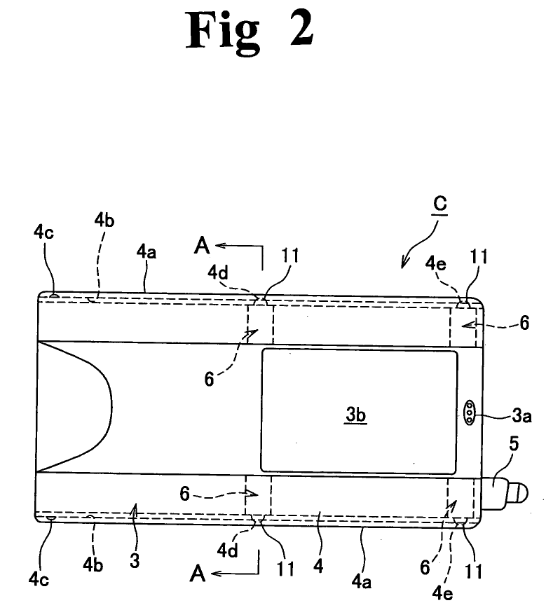

Since the respective hinge devices 6 and so on are the same in structure in all embodiments described above, explanation will be made for the one shown by the arrow A in FIG. 2. The hinge case 7 is of a cylindrical shape provided with turn-stoppers 9 and 9 consisting of striped grooves in the axial direction of both outsides thereof, and is stopped turning by engaging turn-stoppers 10 and 10, and turn-stoppers 9 and 9, set inside the setting hole 8, consisting of convex-striped portion protruding in the axial direction on both sides of the setting hole 8. It should be noted that the shape of the turn-stopper is not limited to the ones described in the embodiment, and the sides providing the striped groove and convex-striped portion can be reversed.

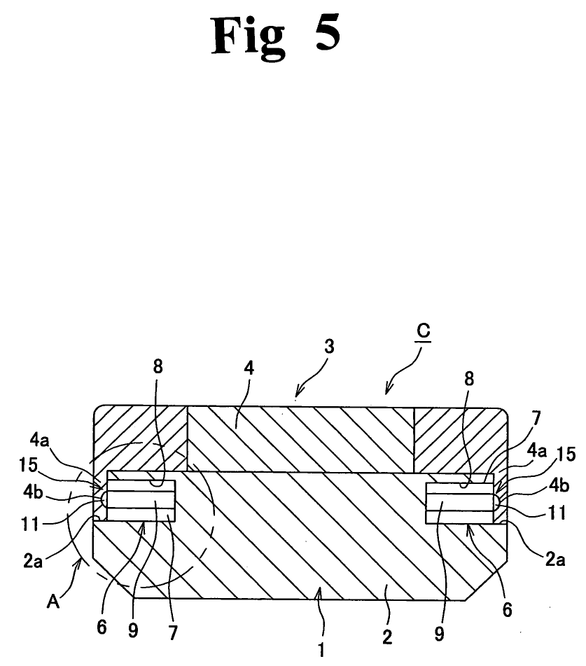

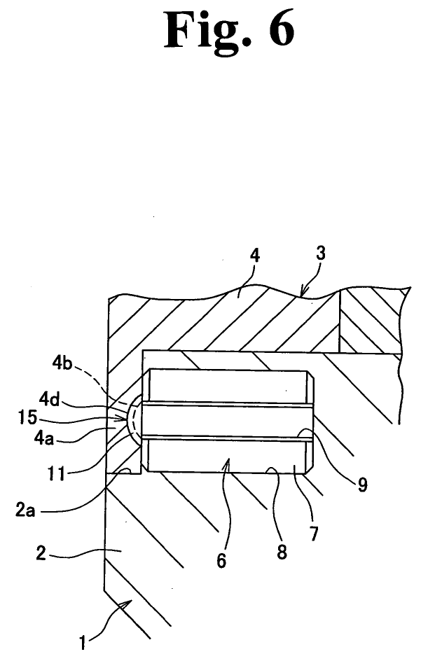

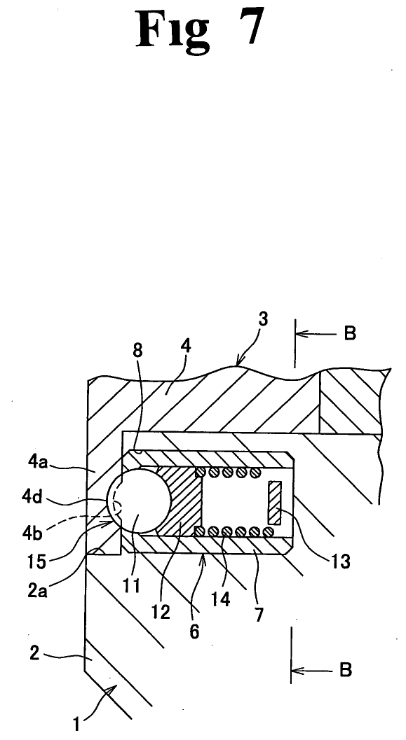

A guide member 11 composed of a ball bearing is attached at an end of the hinge case 7 to be rotatable and not to come out in the outside. This guide member 11 projects from the setting hole 8 to be structured to engage with the guide grooves 4b and 4b provided on the box 4 of the receiver 3 being the second member to structure an engagement means 15 which prevents the box 2 and the box 4 to separate from each other especially as shown in FIG. 5 to FIG. 7.

The guide member 11 is movably supported by a receiving portion 12 slidably set inside the hinge case 7, and biased in the direction to protrude toward outside of the hinge case 7 together with the receiving portion 12 by a compression spring 14 resiliently installed between the receiving portion 12 and a stopper member 13 provided in the rear portion of the hinge case 7.

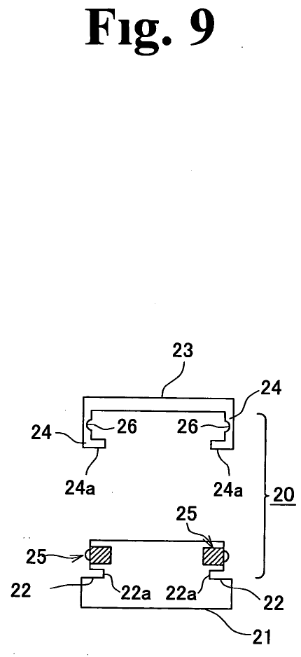

FIG. 9 shows another embodiment of an engagement means between a box of the transmitter and a box of the receiver, and according to the drawings, an engagement means 20 of this embodiment is provided with an engagement groove 22a digging into a box 21 of the transmitter further inside from a shelf portion 22, and structured that an engagement piece 24a, provided to be bent toward inside further than the bottom end portion of a skirt portion 24 of a box 23 of the receiver, is engaged with the engagement groove 22a. The structure of another hinge device 25 and a guide groove 26 engaging with the guide member of this hinge device is the same as the previous embodiment.

When structuring like this, the object of the invention can also be achieved, and in the case of this embodiment, the attachment position of the hinge device 25 can be upper side or lower side sandwiching the engagement groove 22a of the box 21 of the transmitter.

At this time, the position of a guide groove 26 will be on the upper side or lower side of the engagement piece 24a or on the lower side of the box 23 of the receiver to match with the above structure.

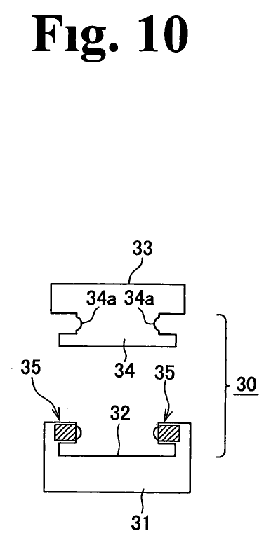

FIG. 10 shows still another embodiment of an engagement means, and according to the drawings, in an engagement means 30 relating to this embodiment, a dovetail groove 32 is provided on the central portion of a box 31 of the transmitter, and an engagement member 34 engaging with the dovetail groove 32 is formed on a box 33 of the receiver. A hinge device 35 is attached on the dovetail groove 32 from the bottom portion thereof to upward, and the guide groove 34a is provided at the position engaging with the guide member of the hinge device 35 on the engagement member 34 side.

When performed even this way, the object of the present invention can be achieved, and when it is carried out in this way, the hinge device 35 can be attached on eaves 32a of the dovetail 32 in a horizontal direction. Accordingly, the position of the guide groove is to be transferred.

Accordingly, as shown in FIG. 1 and FIG. 2, a locked state is kept by fitting and engaging the respective guide members 11 of the respective hinge devices in and with the recessed portions 4d, 4d, 4e, and 4e of the respective guide grooves 4b and 4b in a state of the box 2 on the transmitter 1 and the box 4 on the receiver 3 being overlapped one another.

From this state, when the transmitter 1 being the first member is held with one hand, and the box 4 of the receiver 3 being the second member is pushed forward with the other hand, the locked state between the respective guide members 11 and the recessed portions 4d, 4d, 4e, and 4e of the respective guide grooves 4b and 4b is released. Then, the respective guide members 11 are guided due to the engagement with the respective guide grooves 4b, and 4b to enable sliding, so that the receiver 3 moves forward while it goes up a little to allow the top face of the transmitter 1 being the first member to be exposed.

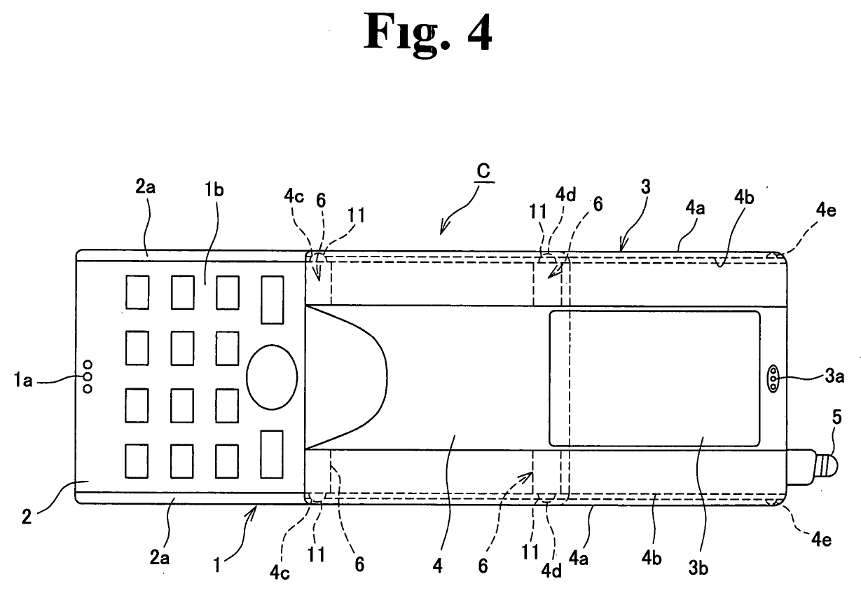

This slide movement is stopped and locked at a position where the respective guide members 11 are fitted into and engaged with the recessed portions 4c, 4c, and 4d, 4d provided in the respective guide grooves 4b and 4b. FIG. 4 shows this state, and it becomes possible for an operator to perform key operation of the key board section 1b on the box 2 of the transmitter 1. At the same time, as shown in FIG. 4 especially, since the receiver 3 forms an obtuse angle with the transmitter 1 to be in the shape of nearly the letter V when seen from the side so that the operator can operate the keyboard while looking a content displayed on the display device 3b, and when having a conversation through a portable phone held with a hand, the microphone section 1a comes to close to the mouth of the operator, and the speaker section 3a comes to close to the ear of the operator, which results in improvement in operatability.

When the operator put back the receiver 3 in its place after operation of the portable phone, the locked state of the respective guide members 11 to the recessed portions 4d, 4d, 4e, and 4e are released by pulling the box 4 toward the operator, the box 4 is moved back to its original position while the respective guide members 11 are being guided by the respective guide grooves 4b, and as described above, it comes in a locked state by engaging the respective guide members 11 with the recessed portions 4d, 4d, 4e, and 4e. Thus, it becomes possible to perform open and close operation of the transmitter 1 and the receiver 3.

Incidentally, it is optional as another embodiment that the hinge device 6 is attached on the box 4 side of the receiver 3, and the guide groove is provided on the box 2 side of the transmitter 1. It is also within the scope of the present invention that shapes of the shelf portion 2a, the guide groove 4b, and the like are not curved unlike the drawings but straight so that the first member and the second member slide in a horizontal direction to each other. Besides, the structure of the hinge device 6 is not limited to the above-described embodiment. For instance, the guide member 11 is not necessarily a ball bearing, and it is enough so far as it is a convex member sliding while engaging with a guide groove. Then, a receiving portion can be formed integrally with the convex member. Even the stopper member can be omitted by making it only a side wall of the hinge case. Further, when carrying out the present invention according to the embodiment described above, assembling of the hinge device 6 to the box 2 becomes easy, and it is also possible to set the guide member 11 and compression spring 14 inside the setting hole 8 provided on the box 2 while omitting the provision of the hinge case 7.

What is claimed is:

1. A slide mechanism to connect a first member and a second member formed separately from each other to be slidable in one direction to form a closed state in which the first member and the second member overlap one another, and to form an opened state in which the top face of either member is exposed, said slide mechanism comprising:
a hinge device provided with a guide member on the tip attached to one side of either the first member or the second member, allowing the guide member to expose to be movable forward and backward by being biased slidably in one direction;
a recessed portion provided on the other member out of the above-described first and second members to receive the guide member of the hinge device at a predetermined slide position; and
an engagement means to engage to prevent the transmitter and the receiver from separating.

2. A portable phone and the slide mechanism according to claim 1, further comprising:
a hinge device provided with a guide member attached on the front end of a hinge case installed on both sides of either one of the first member or the second member facing toward both sides of the other member, allowing the guide member to exposed to be movable forward and backward by being biased slidably in one direction;
a guide groove provided on the other member out of said first member and said second member to guide said guide member of the hinge device in an engaged state; and
an recessed portion to receive and lock the guide groove at an appropriate position of said guide groove.

3. The slide mechanism according to claim 2, wherein said guide groove is disposed in a bent state so that the second member forms an obtuse angle with the first member when the first member and the second member are in an opened state.

4. A portable phone, comprising:
a box of a transmitter composing a first member; and
a box of a receiver composing a second member separately,
wherein said portable phone forms a closed state covering the top face of said transmitter with said receiver, and an opened state of sliding said receiver in one direction from said transmitter to expose the top face thereof by connecting the transmitter and the receiver slidably to each other via the slide mechanism according to claim 1.

5. The portable phone according to claim 4, wherein said guide groove is provided in a bent shape so that said receiver forms an obtuse angle with said transmitter by lifting a sliding tip end of the receiver slightly during sliding of said receiver when said transmitter and said receiver are in an opened state.

6. A portable phone, comprising:
a box of a transmitter composing a first member; and
a box of a receiver composing a second member separately,
wherein said portable phone forms a closed state covering the top face of said transmitter with said receiver, and an opened state of sliding said receiver in one direction from said transmitter to expose the top face thereof by connecting the transmitter and the receiver slidably to each other via the slide mechanism according to claim 2.

7. The portable phone according to claim 6, wherein said guide groove is provided in a bent shape so that said receiver forms an obtuse angle with said transmitter by lifting a sliding tip end of the receiver slightly during sliding of said receiver when said transmitter and said receiver are in an opened state.

8. A portable phone, comprising:
a box of a transmitter composing a first member; and
a box of a receiver composing a second member separately,
wherein said portable phone forms a closed state covering the top face of said transmitter with said receiver, and an opened state of sliding said receiver in one direction from said transmitter to expose the top face thereof by connecting the transmitter and the receiver slidably to each other via the slide mechanism according to claim 3.

9. The portable phone according to claim 8, wherein said guide groove is provided in a bent shape so that said receiver forms an obtuse angle with said transmitter by lifting a sliding tip end of the receiver slightly during sliding of said receiver when said transmitter and said receiver are in an opened state.
